(19) United States
(12) Patent Application Publication
(10) Pub. No.: US 2016/0215206 A1
(43) Pub. Date: Jul. 28, 2016

(54) COATED PARTICLES, INJECTION MATERIAL AND PACKING METHOD

(71) Applicant: SUMITOMO BAKELITE CO., LTD., Tokyo (JP)

(72) Inventors: Fumihiro Maeda, Tokyo (JP); Yasushi Arita, Tokyo (JP); Masakatsu Asami, Tokyo (JP)

(73) Assignee: SUMITOMO BAKELITE CO., LTD., Tokyo (JP)

(21) Appl. No.: 14/907,929

(22) PCT Filed: Jul. 4, 2014
(86) PCT No.: PCT/JP2014/067961

§ 371 Date: Jan. 27, 2016

(30) Foreign Application Priority Data
Jul. 26, 2013 (JP) 2013-156164

(51) Int. Cl. C09K 8/80; E21B 43/267; C09K 8/62

(52) U.S. Cl. CPC C09K 8/805; C09K 8/62; E21B 43/267

(57) ABSTRACT

Coated particles of the present invention are adapted to be packed in fractures formed in a subterranean formation. Each of the coated particles includes: a core particle having an outer surface; and a surface layer coating at least a part of the outer surface of the core particle, wherein the surface layer contains an acid curing agent and an acid curable resin to be cured in the presence of an acid, and wherein the acid curing agent is composed of acidic compounds having acidic groups, and at least a part of the acidic groups of the acidic compounds are blocked by block compounds having reactivity with the acidic groups. This makes it possible to provide the coated particles adapted to be packed in the fractures formed in the subterranean formation and capable of maintaining high fluid permeability thereof, an injection material containing the coated particles, and a packing method for injecting such an injection material into the fractures.

### TECHNICAL FIELD

The present invention relates to coated particles, an injection material and a packing method.

### RELATED ART

Recently, recovery of oily hydrocarbon or gaseous hydrocarbon (a fluid) from a subterranean formation is positively carried out. In particular, a wellbore is formed so as to penetrate the subterranean formation (a shale layer) containing the hydrocarbon, and then the hydrocarbon is recovered through the wellbore. In this case, the subterranean formation is required to have sufficient fluid permeability (conductivity) to allow the fluid to flow into the wellbore.

In order to ensure the fluid permeability of the subterranean formation, for example, hydraulic fracturing is carried out. In the hydraulic fracturing operations, a viscous liquid is first injected into the subterranean formation through the wellbore at a sufficient rate and pressure to thereby form fractures (cracks) in the subterranean formation. After that, an injection material containing particles is injected into the subterranean formation to pack the particles in the formed fractures for the purpose of preventing the fractures from being closed (blocked).

As such particles, coated particles, which are obtained by coating core particles such as silica sand or glass beads with a thermosetting resin such as an epoxy resin or a phenol resin, are well known (see Patent documents 1 and 2).

Since such core particles of the coated particles are coated with the resin, even if the core particles are collapsed into pieces due to the pressure of the ground, it is possible to prevent the pieces thereof from being scattered (spread). This makes it possible to prevent spaces among the coated particles from being closed by the above pieces to thereby maintain the fluid permeability of the subterranean formation.

However, from the viewpoint of improving an amount of the hydrocarbon to be recovered from the subterranean formation, it is required to develop coated particles which can maintain higher fluid permeability of the subterranean formation.

### PRIOR ART DOCUMENT

### Patent Document

Patent document 1: U.S. Pat. No. 3,935,339

Patent document 2: U.S. Pat. No. 4,336,842

### SUMMARY OF THE INVENTION

### Problem to be Solved by the Invention

It is an object of the present invention to provide coated particles adapted to be packed in fractures formed in a subterranean formation and capable of maintaining high fluid permeability thereof, an injection material containing the coated particles, and a packing method for injecting such an injection material into the fractures.

### Means for Solving Problem

In order to achieve the object, the present invention includes the following features (1) to (21).

(1) Coated particles adapted to be packed in fractures formed in a subterranean formation, each of the coated particles comprising:

a core particle having an outer surface; and

a surface layer coating at least a part of the outer surface of the core particle,

wherein the surface layer contains an acid curing agent and an acid curable resin to be cured in the presence of an acid, and

wherein the acid curing agent is composed of acidic compounds having acidic groups, and at least a part of the acidic groups of the acidic compounds are blocked by block compounds having reactivity with the acidic groups.

(2) The coated particles according to the above feature (1), wherein the block compounds have functional groups, and the functional groups are chemically bonded to the acidic groups of the acidic compounds so that the acidic compounds are blocked.

(3) The coated particles according to the above feature (2), wherein the functional groups of the block compounds include at least one selected from the group consisting of a hydroxyl group and an amino group.

(4) The coated particles according to the above feature (2) or (3), wherein the block compounds include an alkyl alcohol having a hydroxyl group as the functional group.

(5) The coated particles according to the above feature (4), wherein the alkyl alcohol is a monovalent alkyl alcohol.

(6) The coated particles according to the above feature (2) or (3), wherein the block compounds include an alkyl amine having an amino group as the functional group.

(7) The coated particles according to any one of the above features (2) to (6), wherein in the case where the number of the acidic groups of the acid curing agent is defined as “1 (one)”, the block compounds are contained in the surface layer so that the number of the functional groups thereof is in the range of 0.1 to 1.9.

(8) The coated particles according to any one of the above features (1) to (7), wherein the acidic groups of the acidic compounds include a sulfonic acid group.

(9) The coated particles according to the above feature (8), wherein the acidic compounds include at least one selected from the group consisting of p-toluene sulfonic acid, benzene sulfonic acid, dodecyl benzene sulfonic acid, phenol sulfonic acid, naphthalene sulfonic acid, dinonyl naphthalene sulfonic acid and dinonyl naphthalene disulfonic acid.

(10) The coated particles according to any one of the above features (1) to (9), wherein an amount of the acid curing agent contained in the surface layer is in the range of 0.1 to 20 parts by mass with respect to 100 parts by mass of the acid curable resin.

(11) The coated particles according to any one of the above features (1) to (10), wherein the acid curable resin is cured at a temperature of 100° C. or lower due to the action of the acidic compounds.

(12) The coated particles according to any one of the above features (1) to (11), wherein the acid curable resin includes at least one selected from the group consisting of a flan resin and a phenol resin.

(13) The coated particles according to any one of the above features (1) to (12), wherein the acid curable resin is in a cured state, a semicured state or an uncured state.

(14) The coated particles according to any one of the above features (1) to (13), wherein an average thickness of the surface layer is in the range of 0.5 to 20 μm.

(15) The coated particles according to any one of the above features (1) to (14), wherein the surface layer coats 50 to 100% of the outer surface of the core particle.

(16) The coated particles according to any one of the above features (1) to (15), wherein the core particles include at least one kind of sand particles and ceramics particles.

(17) The coated particles according to any one of the above features (1) to (16), wherein an average particle size of the core particles is in the range of 100 to 3,000 μm.

(18) An injection material adapted to be injected into fractures formed in a subterranean formation, the injection material comprising:

the coated particles defined by any one of the above features (1) to (17); and

a fluid which disperses the coated particles therein and transfers the coated particles to the fractures.

(19) The injection material according to the above feature (18), wherein the fluid includes at least one of a solvent, a viscosity modifier, a surfactant, a breaker, a viscosity stabilizer, a gelling agent and a stabilizer.

(20) The injection material according to the above feature (18) or (19), wherein an amount of the coated particles contained in the injection material is in the range of 1 to 99 wt %.

(21) A packing method for packing particles in fractures formed in a subterranean formation by transferring the injection material defined by any one of the above features (18) to (20) to the fractures through a wellbore penetrating the subterranean formation to inject the injection material into the fractures.

### Effects of the Invention

According to the present invention, out of the acid curing agent and the acid curable resin contained in the surface layers of the coated particles, at least a part of the acidic groups of the acidic compounds composing the acid curing agent are blocked by, for example, being chemically bonded to the block compounds having the reactivity with the acidic groups. Therefore, it is prevented that the acidic compounds affect the acid curable resin at an unrequired place. This makes it possible to reliably cure the acid curable resin at a required place. As a result, when the coated particles are injected into packed spaces (the fractures of the subterranean formation), it is possible to effectively suppress or prevent the coated particles from being collapsed to thereby improve fluid permeability of the packed spaces in which the coated particles are packed.

### BRIEF DESCRIPTION OF THE DRAWINGS

FIG. 1 is a partial cross-sectional view showing an embodiment of coated particles according to the present invention.

FIG. 2 is a partial cross-sectional view showing a state that pressure is imparted to the coated particles shown in FIG. 1.

FIG. 3 is a conceptual view for explaining a method for recovering hydrocarbon from a subterranean formation.

FIG. 4 is a view for explaining a method for measuring fluid permeability.

### MODE FOR CARRYING OUT THE INVENTION

Hereinafter, preferred embodiments of coated particles, an injection material and a packing method according to the present invention will be described in detail with reference to the accompanying drawings.

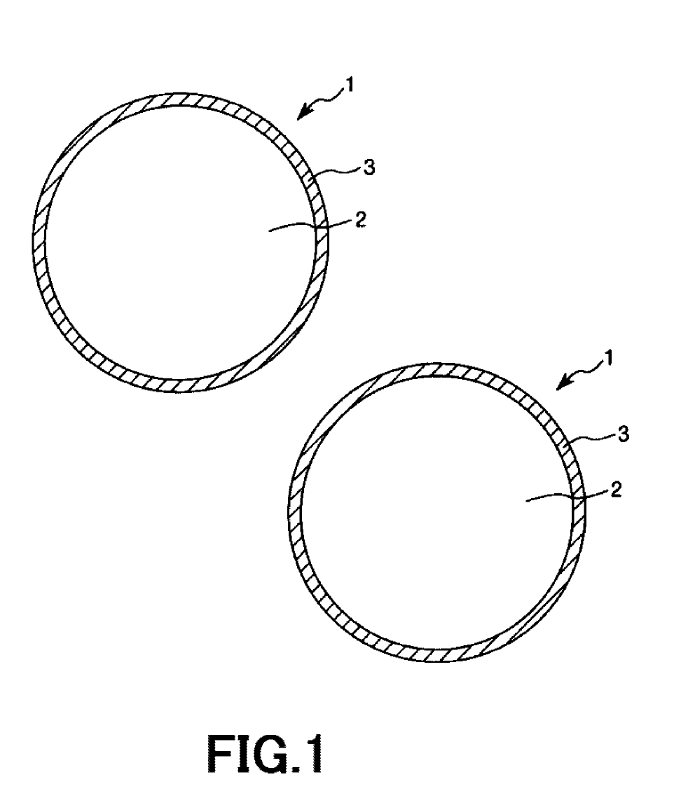

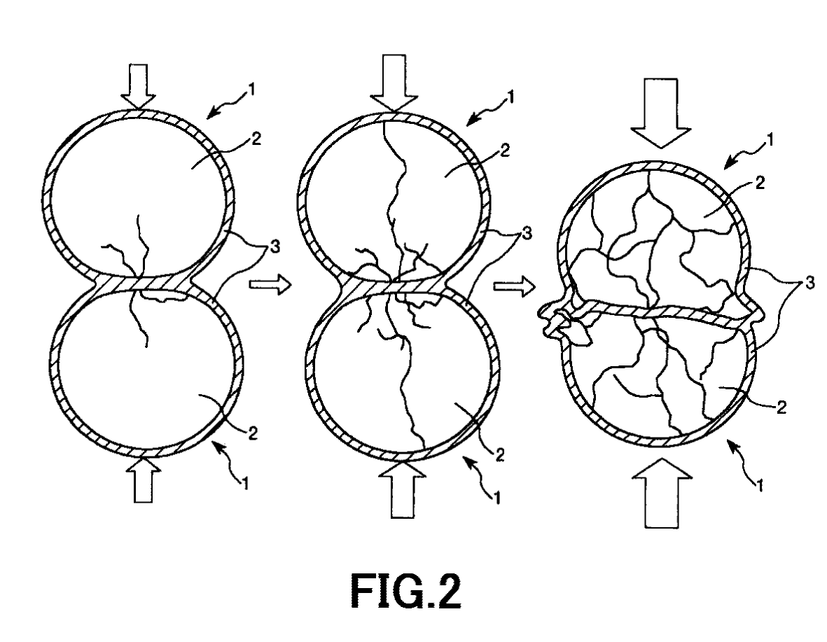

FIG. 1 is a partial cross-sectional view showing an embodiment of the coated particles according to the present invention, and FIG. 2 is a partial cross-sectional view showing a state that pressure is imparted to the coated particles shown in FIG. 1.

The coated particles of the present invention are packed in fractures formed in a subterranean formation to prevent closure of the fractures and maintain fluid permeability of packed spaces of the subterranean formation in which the coated particles are packed (the fractures of the subterranean formation). This makes it possible to improve a flowing rate of hydrocarbon (a shale gas or a shale oil) contained in the subterranean formation into a wellbore formed so as to penetrate the subterranean formation.

As shown in FIG. 1, each coated particle 1 includes a core particle 2 and a surface layer 3 coating at least a part of an outer surface of the core particle 2.

The core particles 2 serve as a propping agent in the fractures when the coated particles 1 are packed in the fractures.

As the core particles 2, various kinds of particles having relatively high mechanical strength can be used. The core particles 2 are not limited to a specific kind. Concrete examples of the core particles 2 include sand particles, ceramics particles, silica particles, metal particles, organic particles, and the like.

Among them, it is preferred that the core particles 2 include at least one kind of the sand particles and the ceramics particles. The sand particles and the ceramics particles have high mechanical strength and can be easily obtained at relatively low cost.

An average particle size of the core particles 2 is preferably in the range of about 100 to 3,000 μm, and more preferably in the range of about 200 to 1,000 μm. By using the core particles 2 having such an average particle size, it is possible to prevent aggregation of the resulting coated particles 1. Further, it is also possible to sufficiently maintain the fluid permeability of the fractures in which the coated particles 1 are packed.

In this regard, the core particles 2 may have variations in the particle size, and may contain one kind and another kind having about 10 times larger particle size than that of the one kind. Namely, when a size distribution of the core particles 2 is measured, a half width of a peak of a size distribution curve shown as a chevron function may be a relatively large value.

In FIG. 1, a cross-sectional shape of the core particle 2 is depicted as a substantially circular shape, but may be an ellipsoidal shape, a polygonal shape, an irregular shape or the like. In this case, the particle size of the core particle 2 is defined as a maximum length in a cross-sectional shape thereof.

In the case where the ceramics particles are used as the core particles 2, it is preferred that each ceramics particle has a nearly circular shape as possible in the cross-sectional shape thereof. Such ceramics particles have especially high mechanical strength. Further, by manufacturing the coated particles 1 with such ceramics particles, it is possible to increase sphericity of the resulting coated particles 1. As a result, contacts among the coated particles 1 become point contacts when the coated particles 1 are packed in the fractures. This makes it possible to increase volumes of spaces (channels) created among the coated particles 1.

Further, natural sand particles may be directly used as the core particles 2. By using such sand particles as the core particles 2, it is possible to improve productivity of the injection material and save cost thereof. Furthermore, a mixture of the ceramics particles and the sand particles may be used as the core particles 2. In this case, a mixing ratio of the ceramics particles to the sand particles is preferably in the range of about 1:9 to 9:1, and more preferably in the range of about 3:7 to 7:3 in a mass ratio.

At least a part of the outer surface of each core particle 2 is coated with the surface layer 3. Even if the coated particles 1 packed in the fractures of the subterranean formation are collapsed into pieces due to the pressure of the ground, this surface layer 3 can operate to prevent the pieces of the core particles 2 from being scattered (spread) as shown in FIG. 2. For this reason, it is possible to prevent the spaces (channels) among the coated particles 1 from being closed by the pieces of the core particles 2. This makes it possible to more reliably maintain the fluid permeability of the fractures in which the coated particles 1 are packed.

The surface layer 3 preferably coats the entire outer surface of each core particle 2. However, the surface layer 3 may coat only a part of the outer surface of each core particle 2 as long as it prevents the pieces of the core particles 2 from being scattered even if the core particles 2 are collapsed into the pieces due to the pressure of the ground. For the reasons stated above, the surface layer 3 preferably coats 50 to 100% of the outer surface of each core particle 2, more preferably coats 70 to 100% thereof, and even more preferably coats 90 to 100% thereof.

Further, an average thickness of the surface layer 3 is not limited to a specific value, but is preferably in the range of 0.5 to 20 μm, and more preferably in the range of 1 to 10 μm. By setting the average thickness of the surface layer 3 to a value falling within the above range, it is possible to sufficiently provide a scattering prevention effect of the pieces of the core particles 2, while preventing the sizes of the coated particles 1 from becoming large more than necessary.

Such a surface layer 3 contains an acid curing agent composed of acidic compounds of which at least a part of acidic groups are blocked, and an acid curable resin to be cured in the presence of an acid, that is, due to the action of the acidic compounds. By curing the acid curable resin due to the action of the acidic compounds, it is possible to impart high mechanical strength to the surface layer 3, and to reliably prevent the pieces of the core particles 2 from being scattered even if the core particles 2 are collapsed into the pieces.

In this regard, the acid curable resin has only to be cured in a state that the coated particles 1 are packed in the fractures of the subterranean formation.

Thus, the acid curable resin may be in either a cured state, a semicured state or an uncured state before the coated particles 1 are packed in the fractures. In the case where the acid curable resin is in the semicured state or the uncured state, it is cured due to the action of the acidic compounds under the conditions of the heat and pressure of the ground when the coated particles 1 are packed in the fractures of the subterranean formation.

Hereinafter, description will be made on a process in which the acidic compounds and the acid curable resin are reacted with each other to cure the acid curable resin.

According to the present invention, in this surface layer 3, at least a part of the acidic groups of the acidic compounds, which has reactivity with the acid curable resin, are blocked by being chemically bonded to block compounds having reactivity with the acidic groups. Further, the block compounds are designed so as to be eliminated from the acidic compounds under the predetermined conditions.

Here, in the case where the acid curable resin is in the cured state before the coated particles 1 are packed in the fractures, the block compounds are eliminated from a lot of the acidic compounds contained in the surface layer 3. In contrast, in the case where the acid curable resin is in the semicured state or the uncured state before the coated particles 1 are packed in the fractures, the block compounds are blocking the acidic compounds by chemically bonding to the acidic groups of the acidic compounds without being eliminated from the majority of the acidic compounds contained in the surface layer 3.

Therefore, it is possible to suppress or prevent the acidic compounds and the acid curable resin from being contacted (reacted) with each other to thereby cure the acid curable resin at an unrequired place. In contrast, the acidic compounds and the acid curable resin can be contacted (reacted) with each other by eliminating the block compounds from the acidic compounds at a required place (that is, the fractures formed in the subterranean formation) to thereby cure the acid curable resin. In other words, the acidic compounds lose the function (reactivity) of curing the acid curable resin by being blocked by the block compounds at the unrequired place, but can cure the acid curable resin by activating the above function due to the elimination of the block compounds at the required place.

In this way, the acid curable resin can be selectively cured at the required place (that is, the fractures formed in the subterranean formation) to thereby improve the strength of the surface layer 3. This makes it possible to more reliably maintain the fluid permeability of the packed spaces of the subterranean formation in which the coated particles 1 are packed. Therefore, it is possible to improve the flowing rate of the hydrocarbon into the wellbore communicating with the fractures.

In this regard, in this specification, “blocking” means that the functional groups of the block compounds are chemically bonded to the acidic groups of the acidic compounds to inactivate reactivity of progressing the curing of the acid curable resin by the acidic groups (reactivity with the acid curable resin). Further, “releasing of blocking” means that the functional groups of the block compounds are eliminated from the acidic groups of the acidic compounds to activate the reactivity of progressing the curing of the acid curable resin by the acidic groups.

Further, “chemical bond” has only to inactivate the reactivity of progressing the curing of the acid curable resin due to the reaction of the acidic groups of the acidic compounds with the functional groups of the block compounds, and examples thereof include an intramolecular bond such as a covalent bond or a coordinate bond, and a chemical bond between molecules such as an ionic bond or a Van der Waals bond.

The acidic compounds serve as a catalyst for promoting the curing reaction of the acid curable resin when they make contact with the acid curable resin after the blocking thereof by the block compounds is released.

Such acidic compounds may be any compounds as long as they have the acidic groups, and thus can exhibit the function as the catalyst by the action of the acidic groups. Concrete examples of the acidic compounds include: compounds having sulfonic acid groups as the acidic groups such as p-toluene sulfonic acid, benzene sulfonic acid, dodecyl benzene sulfonic acid, phenol sulfonic acid, naphthalene sulfonic acid, dinonyl naphthalene sulfonic acid, dinonyl naphthalene disulfonic acid, xylene sulfonic acid and methane sulfonic acid; compounds having carboxyl groups as the acidic groups such as acetic acid, lactic acid, maleic acid, benzoic acid and fluoroacetic acid; and the like. One of them can be used or two or more of them can be used in combination.

Among them, it is preferred that the acidic compounds are the compounds having the sulfonic acid groups as the acidic groups. Such compounds having the sulfonic acid groups as the acidic groups are a very good catalyst for the acid curable resin, and the acidic groups thereof can be reliably blocked by the block compounds.

Further, it is preferred that the compounds having the sulfonic acid groups as the acidic groups contain at least one selected from the group consisting of the p-toluene sulfonic acid, the benzene sulfonic acid, the dodecyl benzene sulfonic acid, the phenol sulfonic acid, the naphthalene sulfonic acid, the dinonyl naphthalene sulfonic acid and the dinonyl naphthalene disulfonic acid. The acidic groups of these acidic compounds can be more reliably blocked by the block compounds.

An amount of the acid curing agent contained in the surface layer 3 is preferably in the range of about 0.1 to 20 parts by mass, more preferably in the range of about 0.5 to 15 parts by mass, and even more preferably in the range of about 1 to 10 parts by mass with respect to 100 parts by mass of the acid curable resin contained in the surface layer 3. By setting the amount of the acid curing agent contained in the surface layer 3 to a value falling within the above range, in the case where the blocking of the acidic compounds is released to cure the acid curable resin by the action thereof, even if the blocking of about half of the acidic compounds by the block compounds is not released with some causes, it is possible to secure a sufficient amount of the acidic compounds by which the acid curable resin can be cured.

The block compounds having reactivity with the acidic groups of the acidic compounds block the acidic groups of the acidic compounds. Therefore, in the case where the acid curable resin is in the semicured state or the uncured state before the coated particles 1 are packed in the fractures, the block compounds have a function of suppressing or preventing the acidic compounds and the acid curable resin from being reacted with each other to cure the acid curable resin at the unrequired place. On the other hand, the block compounds also have a function of reacting the acidic compounds and the acid curable resin with each other by being eliminated from the acidic compounds to cure the acid curable resin at the required place.

Such block compounds have the functional groups, and the functional groups are chemically bonded to the acidic groups of the acidic compounds to block the acidic compounds.

The functional groups may be any groups which are reacted with the acidic groups so that the block compounds can be connected (chemically bonded) to the acidic compounds. Specifically, examples of the functional groups include at least one selected from a hydroxyl group, an amino group and the like. Such block compounds having the functional groups exhibit excellent reactivity with the acidic groups of the acidic compounds. Therefore, the acidic compounds can be reliably blocked by the block compounds due to the reaction (the chemical bond) between the functional groups and the acidic groups.

Examples of the block compounds having the hydroxyl groups as the functional groups include alcohols and phenols. Examples of the alcohols include an alkyl alcohol such as a monovalent alkyl alcohol or a polyvalent alkyl alcohol, an alkenyl alcohol, an aromatic alcohol, a heteroring-containing alcohol, and the like. Among them, it is preferred that the block compounds having the hydroxyl groups include the alkyl alcohol. This makes it possible to more reliably block the acidic compounds by the block compounds.

Further, the monovalent alkyl alcohol may be either a monovalent alkyl alcohol having a linear alkyl group (a linear monovalent alkyl alcohol), a monovalent alkyl alcohol having a branch alkyl group (a branch monovalent alkyl alcohol), or a monovalent alkyl alcohol having a cyclic alkyl group (a cyclic monovalent alkyl alcohol).

Specifically, examples of the linear or branch monovalent alkyl alcohol include: methanol; ethanol; propanol such as 1-propanol or 2-propanol; butanol such as 1-butanol, 2-butanol, 2-methyl-1-propanol or 2-methyl-2-propanol; pentanol such as 1-pentanol, 2-pentanol, 3-pentanol, 2-methyl-1-butanol, 3-methyl-1-butanol, 2-methyl-2-butanol or 2,2-dimethyl-1-propanol; hexanol such as 1-hexanol, 2-hexanol, 3-hexanol, 2-methyl-1-pentanol, 2-methyl-2-pentanol, 2-methyl-3-pentanol, 3-methyl-1-pentanol, 3-methyl-2-pentanol, 3-methyl-3-pentanol, 4-methyl-1-pentanol, 4-methyl-1-pentanol, 4-methyl-2-pentanol, 2,3-dimethyl-2-butanol, 3,3-dimethyl-2-butanol, 2-ethyl-1-butanol; heptanol such as 1-heptanol, 2-heptanol, 3-heptanol, 2-methyl-1-hexanol, 2-methyl-2-hexanol, 2-methyl-3-hexanol, 5-methyl-2-hexanol, 3-ethyl-3-pentanol, 2,2-dimethyl-3-pentanol, 2,4-dimethyl-3-pentanol, 4,4-dimethyl-2-pentanol or 3-methyl-1-hexanol; octanol such as 1-octanol, 2-octanol, 3-octanol, 4-methyl-3-heptanol, 6-methyl-2-heptanol, 2-ethyl-1-hexanol, 2-propyl-1-pentanol, 2-methyl-1-heptanol, 2,2-dimethyl-1-hexanol; nonanol such as 1-nonanol, 2-nonanol, 3,5,5-trimethyl-1-hexanol, 2,6-dimethyl-4-heptanol, 3-ethyl-2,2-dimethyl-3-pentanol; decanol such as 1-decanol, 2-decanol, 4-decanol, 3,7-dimethyl-1-octanol, 2,4,6-trimethyl heptanol; undecanol; dodecanol; tridecanol; tetradecanol; heptadecanol; octadecanol such as heptadecanol; nonadecanol; eicosanol; heneicosanol; tricosanol; tetracosanol; and the like. One of them can be used or two or more of them can be used in combination.

Further, examples of the cyclic monovalent alkyl alcohol (cycloalkyl alcohol) include: cyclopentanol; cycloheptanol; methyl cyclopentanol; cyclopentyl methanol; cyclohexyl methanol; 1-cyclohexyl ethanol; 2-cyclohexyl ethanol; 3-cyclohexyl propanol; 4-cyclohexyl butanol; cyclohexanols such as cyclohexanol, methyl cyclohexanol, dimethyl cyclohexanol, tetramethyl cyclohexanol, hydroxy cyclohexanol, (1S,2R,5S)-2-isopropyl-5-methyl cyclohexanol, butyl cyclohexanol and 4-t-butyl cyclohexanol; and the like. One of them can be used or two or more of them can be used in combination.

Furthermore, examples of the polyvalent alkyl alcohol include a divalent alcohol such as ethylene glycol (1,2-ethanediol), 1,2-propanediol or 1,3-propanediol, a trivalent alcohol such as glycerin, a tetravalent alcohol such as pentaerythritol, and the like. One of them can be used or two or more of them can be used in combination.

In this regard, in the case where the acidic compounds having the sulfonic acid groups as the acidic groups are used, they are reacted with the block compounds having the hydroxyl groups as the functional groups to thereby form sulfonic acid ester bonds. In this way, the acidic compounds are blocked by the block compounds. Namely, sulfonic acid esters are produced as the acidic compounds of which the acidic groups are blocked by the block compounds.

On the other hand, examples of the block compounds having the amino groups as the functional groups include: an alkyl amine such as a monovalent alkyl amine or a polyvalent alkyl amine; an alkenyl amine; an aromatic amine; a heteroring-containing amine; and the like. Among them, it is preferred that the block compounds having the amino groups include the alkyl amine. This makes it possible to more reliably block the acidic compounds by the block compounds.

Further, examples of the monovalent alkyl amine include: a monoalkyl amine such as hexyl amine, heptyl amine, octyl amine, nonyl amine, decyl amine, undecyl amine, dodecyl amine, tridecyl amine, tetradecyl amine, pentadecyl amine, hexadecyl amine, octadecyl amine, isopropyl amine, isoamyl amine or 3,3-dimethyl butyl amine; a dialkyl amine such as N-ethyl butyl amine, dibutyl amine, dipentyl amine, dihexyl amine, diheptyl amine, dioctyl amine, dinonyl amine, didecyl amine, N-methyl cyclohexyl amine or dicyclohexyl amine; a trialkyl amine such as trimethyl amine, triethyl amine, tripropyl amine, tributyl amine or trioctyl amine; and the like. One of them can be used or two or more of them can be used in combination.

Furthermore, examples of the polyvalent alkyl amine include: a diamine such as ethylene diamine, hexamethylene diamine, diethylene triamine, triethylene tetramine, tetraethylene pentamine or pentaethylene hexamine; a triamine such as bis(hexamethylene) triamine; and the like. One of them can be used or two or more of them can be used in combination.

In this regard, in the case where the acidic compounds having the sulfonic acid groups as the acidic groups are used, they are reacted with the block compounds having the basic amine groups as the functional groups to thereby form salts by neutralization (ionic bonds). In this way, the acidic compounds are blocked by the block compounds. Namely, sulfonic acid amine salts are produced as the acidic compounds of which the acidic groups are blocked by the block compounds.

Further, in the case where the number of the acidic groups of the acid curing agent is defined as “1 (one)”, the block compounds are contained in the surface layer 3 so that the number of the functional groups thereof is preferably in the range of 0.1 to 1.9, more preferably in the range of 0.3 to 1.7, and even more preferably in the range of 0.5 to 1.5.

In this regard, a method for producing the acidic compounds of which the acidic groups are blocked by the block compounds is not limited to a specific method. In the case where the acidic compounds are carboxylic acids having carboxyl groups, and the block compounds are alcohols or phenols having hydroxyl groups, for example, the carboxylic acids and the alcohols or phenols are mixed with each other, and then heated by using concentrated sulfuric acid or the like as a catalyst so that a dehydration condensation reaction therebetween occurs. In this way, it is possible to produce carboxylic acid esters which are the acidic compounds of which the acidic groups are blocked.

Further, in the case where the acidic compounds are sulfonic acids having sulfonic acid groups, and the block compounds are the alcohols or phenols having the hydroxyl groups, for example, sulfonic acid chlorides and the alcohols or phenols are reacted with each other by using pyridine as a solvent. In this way, it is possible to produce sulfonic acid esters which are the acidic compounds of which the acidic groups are blocked.

On the other hand, in the case where the acidic compounds are the carboxylic acids having the carboxyl groups or the sulfonic acids having the sulfonic acid groups, and the block compounds are amines having amine groups, for example, the carboxylic acids or sulfonic acids and the amines are mixed with each other while being heated so that a neutralization reaction therebetween occurs. In this way, it is possible to produce sulfonic acid salts or carboxylic acid salts which are the acidic compounds of which the acidic groups are blocked.

Further, examples of the acid curable resin include a furan resin, a phenol resin, a melamine resin, a urea resin, an oxetane resin, and the like. One of them can be used or two or more of them can be used in combination. Among them, it is preferred that the acid curable resin includes at least one selected from the group consisting of the flan resin and the phenol resin. Since such an acid curable resin is easily cured at about room temperature in the presence of an acid such as the acidic compounds (the acidic groups of the acidic compounds), it is especially appropriate to use in the present invention. Furthermore, by using such a resin, it is possible to impart especially high mechanical strength to the surface layer 3.

Examples of the furan resin include a furfural resin, a furfural phenol resin, a furfural ketone resin, a furfuryl alcohol resin, a furfuryl alcohol phenol resin, and the like.

Examples of the phenol resin include a resol-type phenol resin, an alkylene etherified resol-type phenol resin, a dimethylene ether-type phenol resin, an aminomethyl-type phenol resin, a novolac-type phenol resin, an aralkyl-type phenol resin, a dicyclopentadiene-type phenol resin, and the like.

Further, in the coated particles 1 each having the above configuration, the acid curable resin is cured at a temperatures of preferably 100° C. or lower, more preferably 75° C. or lower, and even more preferably 25° C. (room temperature) or lower by the action of the acidic compounds which are not blocked by the block compounds (unblocked forms of the acidic compounds). By selecting such an acid curable resin, the coated particles 1 can be especially appropriately used in the case where the hydrocarbon is collected from a subterranean formation located at a relatively shallow place by using the injection material containing the coated particles 1.

As described above, even if the acid curable resin is cured by the action of the acidic compounds at a relatively low temperature, in such an injection material, out of the acid curing agent and the acid curable resin, at least a part of the acidic groups of the acidic compounds composing the acid curing agent are blocked by the block compounds. Therefore, before the block compounds are eliminated from the acidic compounds, it is possible to appropriately suppress or prevent the acid curable resin from being cured.

In this regard, the acidic groups of almost all acidic compounds are preferably blocked by the block compounds, but the acidic groups of only a part (e.g., preferably 60% or more, more preferably 75% or more, and even more preferably 90% or more) of the acidic compounds may be blocked by the block compounds.

The surface layer 3 may further contain components other than the above mentioned components such as the acid curing agent and the acid curable resin.

Examples of the other components include a lubricant (wax), a coupling agent, a toughening agent, and the like. For example, the lubricant has a function of improving conformability between the fluid and the resin (the surface layer 3), and the coupling agent has a function of improving adhesiveness between the core particle 2 and the surface layer 3.

Examples of the lubricant include ethylene bisstearic acid amide, methylene bisstearic acid amide, oxystearic acid amide, stearic acid amide, methylol stearic acid amide, hydrocarbon wax, stearic acid, and the like. On the other hand, examples of the coupling agent include a silane coupling agent such as aminosilanee, epoxysilane or vinylsilane, a titanate coupling agent, and the like.

In this regard, according to this embodiment shown in FIG. 1, the surface layer 3 is depicted so as to directly make contact with the core particle 2. However, at least one intermediate layer having an arbitrary function may be provided between the core particle 2 and the surface layer 3. Examples of such a function of the intermediate layer include a function of improving adhesiveness between the core particle 2 and the surface layer 3, and the like.

The above mentioned coated particles 1 can be manufactured by using manufacturing methods of coated particles I to III described below.

First, according to the manufacturing method of coated particles I, a resin composition, which contains the acid curable resin, and the acid curing agent composed of the acidic compounds of which the at least a part of the acidic groups are blocked, is prepared, at least a part of the outer surface of each core particle 2 is coated with a layer containing the resin composition by mixing the resin composition with the core particles 2 or by applying or spraying the resin composition onto the outer surface of each core particle 2, and then they are cooled. In this way, it is possible to manufacture the coated particles 1, in each of which the surface layer 3 is formed on the at least a part of the outer surface of the core particle 2.

Further, in the manufacturing method of coated particles I, the above steps may be repeatedly carried out multiple times. In this case, formulations of the resin compositions used in the repeating steps may be the same as or different from each other every time. In this regard, according to the manufacturing method of coated particles I, the surface layer 3 is formed on the at least a part of the outer surface of each core particle 2 in a state that the acid curable resin and the acid curing agent (including the acidic compounds and the acidic compounds of which the acidic groups are blocked) are substantially uniformly mixed with each other in a thickness direction thereof.

Next, according to the manufacturing method of coated particles II, a first resin composition containing the acid curable resin and a second resin composition containing the acid curing agent composed of the acidic compounds of which the at least a part of the acidic groups are blocked are respectively prepared, at least a part of the outer surface of each core particle 2 is coated with a layer containing the first resin composition and the second resin composition by first mixing the first resin composition with the core particles 2, and further adding and mixing the second resin composition thereto, and then they are cooled. In this way, it is possible to manufacture the coated particles 1, in each of which the surface layer 3 is formed on the at least a part of the outer surface of the core particle 2.

Further, in the manufacturing method of coated particles II, the above steps for coating each core particle 2 with such a layer containing the first resin composition and the second resin composition may be repeatedly carried out multiple times. In this case, formulations of the respective resin compositions used in the repeating steps may be the same as or different from each other every time. In this regard, according to the manufacturing method of coated particles II, the surface layer 3 is formed on the at least a part of the outer surface of each core particle 2 in a state that an amount of the acid curable resin out of the acid curable resin and the acid curing agent (including the acidic compounds and the acidic compounds of which the acidic groups are blocked) is decreased from a core particle 2 side toward a surface side in the thickness direction thereof.

Next, according to the manufacturing method of coated particles III, the first resin composition containing the acid curable resin and the second resin composition containing the acid curing agent composed of the acidic compounds of which the at least a part of the acidic groups are blocked are respectively prepared, at least a part of the outer surface of each core particle 2 is coated with a laminated body constituted from a layer containing the first resin composition and a layer containing the second resin composition by first mixing the first resin composition with the core particles 2 and cooling them, and further adding and mixing (dusting) the second resin composition thereto. In this way, it is possible to manufacture the coated particles 1, in each of which the surface layer 3 is formed on the at least a part of the outer surface of the core particle 2.

Further, in the manufacturing method of coated particles III, the above steps for coating each core particle 2 with such a layer containing the first resin composition and such a layer containing the second resin composition may be repeatedly carried out multiple times. In this case, formulations of the respective resin compositions used in the repeating steps may be the same as or different from each other every time. In this regard, according to the manufacturing method of coated particles III, the surface layer 3 is formed on the at least a part of the outer surface of each core particle 2 as the laminated body in which the layer containing the acid curable resin and the layer containing the acid curing agent (including the acidic compounds and the acidic compounds of which the acidic groups are blocked) are laminated with each other in this order from the core particle 2 side in the thickness direction thereof.

In this regard, a weight average molecular weight of the acid curable resin, which is used in the manufacturing methods of coated particles I to III, is preferably in the range of 200 to 50,000, and more preferably in the range of 2,000 to 30,000. The resin composition (the first resin composition) containing the acid curable resin having the above weight average molecular weight exhibit relatively low viscosity. Therefore, it is possible to easily and reliably mix the resin composition and the core particles 2 with each other.

Since an amount of the acid curable resin contained in the resin composition (the first resin composition) is appropriately set depending on a predetermined amount of the acid curable resin contained in the surface layer 3, it is not limited to a specific value, but is preferably in the range of about 70 to 99 mass %, and more preferably in the range of about 85 to 99 mass %.

Further, since an amount of the acid curing agent contained in the resin composition (the second resin composition) is appropriately set depending on a predetermined amount of the acid curing agent contained in the surface layer 3, it is not limited to a specific value, but is preferably in the range of about 0.001 to mass %, and more preferably in the range of about 0.05 to 6 mass %.

In this regard, by respectively setting the amounts of the acid curable resin and the acid curing agent contained in the resin composition to values falling within the above ranges, it is possible to prevent the viscosity of the resin composition from becoming high. As a result, it is possible to easily handle the resin composition.

The resin composition (the first and second resin compositions) may contain a liquid agent capable of dissolving or dispersing the above respective components therein. This makes it possible to easily adjust the viscosity of the resin composition. In the case where the resin composition contains the liquid agent, it is preferred that the at least a part of the outer surface of each core particles 2 is coated with the resin composition, and then the liquid agent is removed from the resin composition by, for example, air drying or the like. This makes it possible to prevent the resin composition (the surface layer 3) from being released from each core particle 2 and uniform the thickness of the surface layer 3.

Examples of such a liquid agent include water; an alcohol-based liquid agent such as methanol, ethanol or propanol; a ketone-based liquid agent such as acetone or methyl ethyl ketone; an ester-based liquid agent such as methyl acetate or ethyl acetate; and the like. In this regard, as the liquid agent, one of these compounds can be used or two or more of these compounds can be used in combination.

In this regard, in the case where the acid curable resin, which is contained in the surface layers 3 of the coated particles 1 manufactured by using the manufacturing methods of coated particles I to III, is brought into the cured state or the semicured state, the curing of this acid curable resin can be easily carried out by heating the surface layers 3 formed on the outer layers of the core particles 2.

In the present invention, the at least a part of the acidic compounds contained in the surface layers 3 are existing in a blocked state that the acidic groups are chemically bonded to the block compounds, and the block compounds are designed to be eliminated from the acidic groups by heating the surface layers 3. Therefore, it is possible to set a heating temperature during the heating low to thereby reduce energy required for the heating.

The heating temperature of heating the surface layers 3 is preferably in the range of 30 to 250° C., and more preferably in the range of 60 to 200° C.

Further, a heating time of heating the surface layers 3 is preferably in the range of 0.1 to 60 minutes, and more preferably in the range of 0.1 to 5 minutes.

By setting the conditions of heating the surface layers 3 to be within the above ranges, it is possible to reliably bring the acid curable resin contained in the surface layers 3 into the cured state or the semicured state.

Further, a method for heating the surface layers 3 is not limited to a specific method. For example, the surface layers 3 may be heated after the surface layers 3 are formed on the outer surfaces of the core particles 2, or the surface layers 3 may be heated by heating the core particles 2 in advance, and then forming the surface layers 3 onto the core particles 2.

Prior to packing the above mentioned coated particles 1 in the fractures formed in the subterranean formation, an injection material is prepared by dispersing the coated particles 1 in a fluid for transferring them to the fractures. Such an injection material is transferred through the wellbore penetrating the subterranean formation, and then injected into the fractures.

The fluid used for preparing the injection material is preferably the same as the fluid used for forming the fractures in the subterranean formation. A viscosity at 25° C. of the fluid is preferably in the range of 10 to 500 mPa·s, more preferably in the range of 15 to 300 mPa·s, and even more preferably in the range of 20 to 100 mPa·s. By using the fluid having the above viscosity, it is possible to reliably form the fractures in the subterranean formation. Further, it is also possible to improve dispersibility of the coated particles 1 in the injection material to thereby efficiently transfer to the fractures and pack the coated particles 1 therein.

Such a fluid is mainly composed of water, and preferably contains at least one compound selected from the group consisting of a solvent, a viscosity modifier, a surfactant, a breaker, a viscosity stabilizer, a gelling agent and a stabilizing agent. By using the above compound, it is possible to easily and reliably adjust the viscosity of the fluid to a value falling within the above range.

An amount of the coated particles 1 contained in the injection material is preferably in the range of about 1 to 99 wt %, and more preferably in the range of 5 to 90 wt %. The injection material containing the coated particles 1 in the above amount can stably disperse the coated particles 1 therein regardless of the viscosity of the fluid.

Next, description will be made on a method for recovering the hydrocarbon from the subterranean formation.

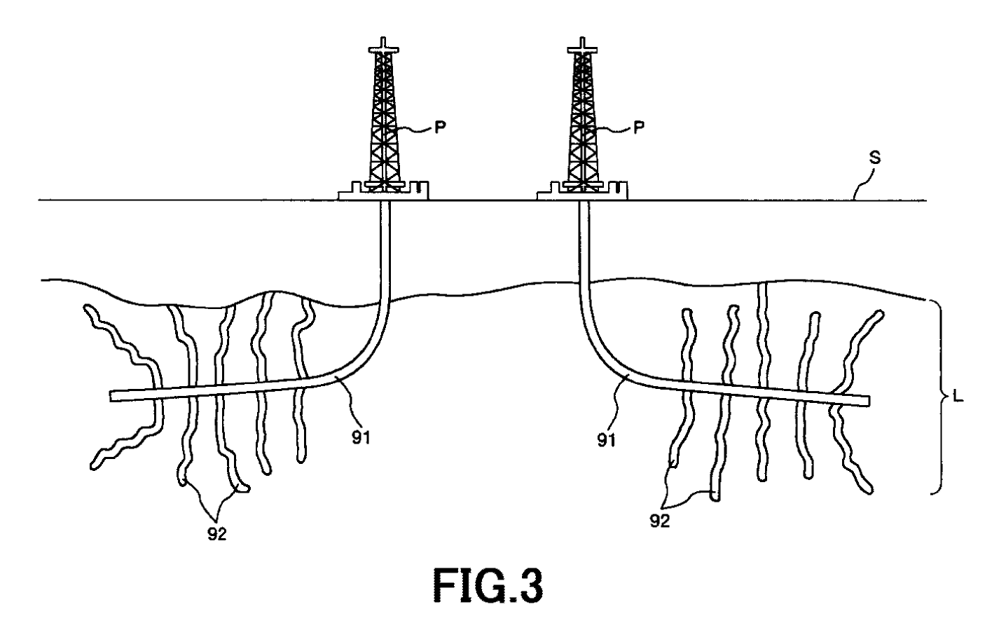

FIG. 3 is a conceptual view for explaining the method for recovering the hydrocarbon from the subterranean formation.

[1] First, as shown in FIG. 3, a wellbore 91 is dug from a land surface S to a desirable (objective) subterranean formation L containing the hydrocarbon in a vertical direction. After the wellbore 91 reaches the subterranean formation L, the digging direction thereof is changed to a horizontal direction, and then the wellbore 91 is dug in the subterranean formation L until the wellbore 91 forwards a predetermined distance in the horizontal direction.

[2] Next, a fluid is injected into the subterranean formation L through the wellbore 91 at a predetermined rate and pressure. At this time, the fluid gradually breaks down soft parts of the subterranean formation L. In this way, a plurality of fractures 92 are formed in the subterranean formation L so as to be communicated with the wellbore 91.

[3] Next, the injection material is injected into the subterranean formation L through the wellbore 91 at a predetermined rate and pressure instead of the fluid. At this time, the injection material is injected into each fracture 92 so that the coated particles 1 are packed in each fracture 92. Namely, this step [3] corresponds to the packing method (a method for injecting the injection material into the fractures 92) according to the present invention.

In this regard, it is preferred that this step [3] is carried out with gradually increasing the amount of the coated particles 1 contained in the injection material. This makes it possible to reliably pack the coated particles 1 in each fracture 92 at high density.

By packing the coated particles 1 in each fracture 92 in such a way, it is possible to prevent each fracture 92 from being closed due to the pressure of the ground. In particular, in the case where the acid curable resin is in the cured state before the coated particles 1 are packed in each fracture 92, the surface layers 3 can reliably exhibit the functions thereof at the same time as the coated particles 1 are packed in each fracture 92. Therefore, even if the core particles 2 are collapsed into pieces due to the pressure of the ground, it is possible to appropriately suppress or prevent the pieces thereof from being scattered. Further, just after the coated particles 1 are packed in each fracture 92, the block compounds are eliminated in the blocked acidic compounds remaining in the surface layers 3. Among the coated particles 1 making contact with each other, molecules of the acid curable resin, which exists in the vicinity of surfaces of the surface layers 3, can be reacted with each other. For these reasons, the coated particles 1 can be early fixed with each other in each fracture 92 to thereby suppress or prevent the coated particles 1 from flowing away from each fracture 92.

Further, in the case where the acid curable resin is in the semicured state or the uncured state before the coated particles 1 are packed in each fracture 92, the block compounds are blocking the acidic compounds by chemically bonding to the acidic groups of the acidic compounds without being eliminated from the majority of the acidic compounds contained in the surface layers 3. This makes it possible to suppress or prevent the acidic compounds and the acid curable resin from being contacted (reacted) with each other to thereby cure the acid curable resin at the unrequired place. In contrast, the acidic compounds and the acid curable resin can be contacted (reacted) with each other by eliminating the block compounds from the acidic compounds at the required place (that is, at the fractures 92) to thereby cure the acid curable resin. In this way, the acid curable resin can be selectively cured at the required place (that is, at the fractures 92) to thereby improve the strength of the surface layers 3. This makes it possible to more reliably maintain the fluid permeability of the packed spaces of the subterranean formation in which the coated particles 1 are packed (the fractures of the subterranean formation).

[4] Next, the hydrocarbon is recovered through each fracture 92 and the wellbore 91 from the subterranean formation L by using a pump P provided on the land surface S.

While the coated particles, the injection material and the packing method according to the present invention have been described hereinabove, the present invention is not limited thereto.

### EXAMPLES

Hereinafter, more detailed description will be made on the present invention with reference to examples thereof.

### 1. Manufacture of Coated Particles

### Example 1

First, methyl p-toluene sulfonate (the acidic compounds blocked by forming the sulfonic acid ester bonds; “Methyl p-Toluene sulfonate” produced by TOKYO CHEMICAL INDUSTRY CO., LTD.) as the acidic compounds of which the acidic groups were blocked, a furfuryl alcohol resin as the acid curable resin, and frac sand (sand particles) having an average particle size of 400 μm as the core particles were prepared, respectively.

Next, 100 parts by weight of the frac sand was heated at 100° C. and put into a mixer, and then 3 parts by weight of the furfuryl alcohol resin was added thereto and mixed for 120 seconds to thereby coat each particle of the frac sand with a layer containing the furfuryl alcohol resin. Next, 0.3 parts by weight of the methyl p-toluene sulfonate was added thereto and mixed with each other for 300 seconds to sufficiently impregnate the methyl p-toluene sulfonate into the layer, and thus cure the furfuryl alcohol resin due to demethylation (the releasing of the blocking) of the methyl p-toluene sulfonate. In this way, coated particles were obtained.

In this regard, an entire outer surface (100%) of each particle of the frac sand was coated with a surface layer, and an average thickness thereof was 10 μm. The condition of the outer surfaces of the coated particles (the condition of the surface layers) was confirmed with an optical microscope.

### Examples 2

Coated particles were manufactured in the same manner as Example 1 except that a p-toluene sulfonic acid amine salt (the acidic compounds blocked by forming the sulfonamide bonds; “NACURE 2500” produced by Kusumoto Chemicals, Ltd.) was used as the acidic compounds of which the acidic groups were blocked.

### Comparative Example

Coated particles were manufactured in the same manner as Example 1 except that p-toluene sulfonic acid was used as the acid curing agent (the acidic compounds of which the acidic groups were not blocked) instead of the acidic compounds of which the acidic groups were blocked.

### 2. Evaluation

2-1. Crush Test

40 g of the coated particles obtained in each of Examples and Comparative Example were respectively put into a mold for crushing sand (made by Okuyama mold factory limited private company), and then pressure in the mold was raised for one minute and kept for two minutes at a rotating speed of 14,000 psi. In this way, crush test were carried out.

2-2. Fluid Permeability

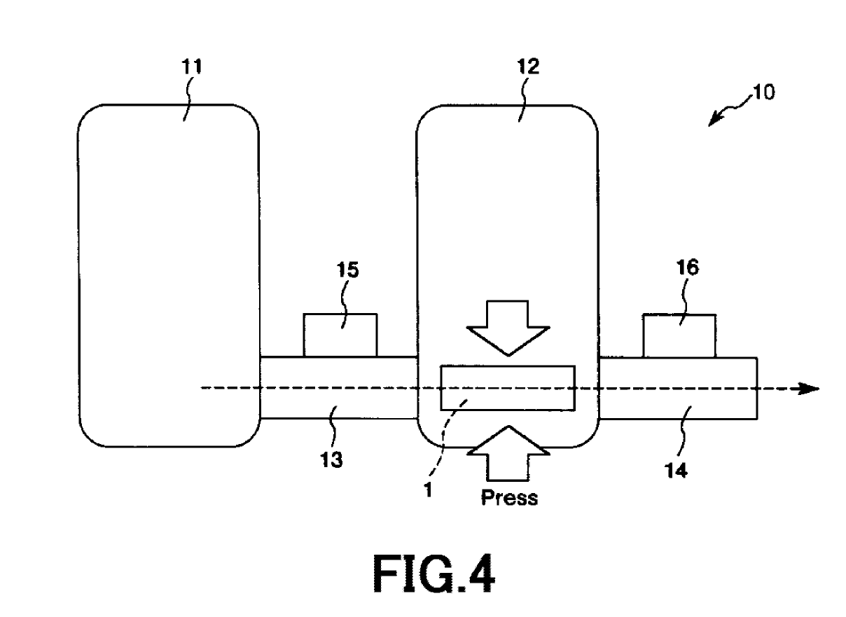

Fluid permeability was measured by using measurement equipment shown in FIG. 4.

This measurement equipment 10 includes a pump 11 capable of sending a liquid, a press machine 12 capable of receiving the coated particles and pressing the coated particles received therein, a pipe 13 connecting with the pump 11 and the press machine 12, and a pipe 14 connected with the press machine 12 at an opposite side to the pump 11. Further, pressure sensors 15 and 16 capable of measuring pressure of the liquid passing through insides of the pipes 13 and 14 are respectively provided thereon.

In such measurement equipment 10, the liquid is transferred from the pump 11 to the press machine 12 through the pipe 13, and then the liquid flowing the inside of the press machine 12 is wasted through the pipe 14. At this time, pressures of the liquid flowing through the insides of the pipes 13 and 14 are respectively measured by the pressure sensors 15, 16, and then a pressure difference therebetween is obtained. This pressure difference can be defined as the fluid permeability of the inside of the press machine 12 (the packed spaces in which the coated particles 1 are packed).

In this regard, at the time of measuring the fluid permeability actually, 2% KCl aqueous solution was used as the liquid and the pressure of the liquid transferred from the pump 11 was set to 10 Kpsi.

In these results, emergence amounts of dust (pieces) of the coated particles obtained in each of Examples by the crush test were not different from each other. Further, the above emergence amounts were not also different from that of the coated particles obtained in Comparative Example.

In contrast, the coated particles obtained in each of Examples obviously indicate high fluid permeability as compared with the coated particles obtained in Comparative Example. This seems to be because only the vicinities of the surfaces of the surface layers of the coated particles were brought into the cured state by using the p-toluene sulfonic acid as the acidic compounds of which the acidic groups were not blocked in Comparative Example. Such a state is likely to be generated as follows. Namely, during the manufacture of the coated particles, at the same time as the p-toluene sulfonic acid made contact with the layers containing the furfuryl alcohol resin, the furfuryl alcohol resin existing in the vicinities of the surfaces thereof was cured, whereas the p-toluene sulfonic acid could not be penetrated into the insides of the layers to thereby not sufficiently progress the curing reaction of the furfuryl alcohol resin.

### INDUSTRIAL APPLICABILITY

According to the present invention, each of coated particles adapted to be packed in fractures formed in a subterranean formation includes: a core particle having an outer surface; and a surface layer coating at least a part of the outer surface of the core particle, wherein the surface layer contains an acid curing agent and an acid curable resin to be cured in the presence of an acid, and wherein the acid curing agent is composed of acidic compounds having acidic groups, and at least a part of the acidic groups of the acidic compounds are blocked by block compounds having reactivity with the acidic groups. This makes it possible to provide the coated particles adapted to be packed in the fractures formed in the subterranean formation and capable of maintaining high fluid permeability thereof, an injection material containing the coated particles, and a packing method for injecting such an injection material into the fractures. Therefore, the present invention has industrial applicability.

1. Coated particles adapted to be packed in fractures formed in a subterranean formation, each of the coated particles comprising:
a core particle having an outer surface; and
a surface layer coating at least a part of the outer surface of the core particle,
wherein the surface layer contains an acid curing agent and an acid curable resin to be cured in the presence of an acid, and
wherein the acid curing agent is composed of acidic compounds having acidic groups, and at least a part of the acidic groups of the acidic compounds are blocked by block compounds having reactivity with the acidic groups.

2. The coated particles as claimed in claim 1, wherein the block compounds have functional groups, and the functional groups are chemically bonded to the acidic groups of the acidic compounds so that the acidic compounds are blocked.

3. The coated particles as claimed in claim 2, wherein the functional groups of the block compounds include at least one selected from the group consisting of a hydroxyl group and an amino group.

4. The coated particles as claimed in claim 2, wherein the block compounds include an alkyl alcohol having a hydroxyl group as the functional group.

5. The coated particles as claimed in claim 4, wherein the alkyl alcohol is a monovalent alkyl alcohol.

6. The coated particles as claimed in claim 2, wherein the block compounds include an alkyl amine having an amino group as the functional group.

7. The coated particles as claimed in claim 2, wherein in the case where the number of the acidic groups of the acid curing agent is defined as “1 (one)”, the block compounds are contained in the surface layer so that the number of the functional groups thereof is in the range of 0.1 to 1.9.

8. The coated particles as claimed in claim 1, wherein the acidic groups of the acidic compounds include a sulfonic acid group.

9. The coated particles as claimed in claim 8, wherein the acidic compounds include at least one selected from the group consisting of p-toluene sulfonic acid, benzene sulfonic acid, dodecyl benzene sulfonic acid, phenol sulfonic acid, naphthalene sulfonic acid, dinonyl naphthalene sulfonic acid and dinonyl naphthalene disulfonic acid.

10. The coated particles as claimed in claim 1, wherein an amount of the acid curing agent contained in the surface layer is in the range of 0.1 to 20 parts by mass with respect to 100 parts by mass of the acid curable resin.

11. The coated particles as claimed in claim 1, wherein the acid curable resin is cured at a temperature of 100° C. or lower due to the action of the acidic compounds.

12. The coated particles as claimed in claim 1, wherein the acid curable resin includes at least one selected from the group consisting of a flan resin and a phenol resin.

13. The coated particles as claimed in claim 1, wherein the acid curable resin is in a cured state, a semicured state or an uncured state.

14. The coated particles as claimed in claim 1, wherein an average thickness of the surface layer is in the range of 0.5 to 20 μm.

15. The coated particles as claimed in claim 1, wherein the surface layer coats 50 to 100% of the outer surface of the core particle.

16. The coated particles as claimed in claim 1, wherein the core particles include at least one kind of sand particles and ceramics particles.

17. The coated particles as claimed in claim 1, wherein an average particle size of the core particles is in the range of 100 to 3,000 μm.

18. An injection material adapted to be injected into fractures formed in a subterranean formation, the injection material comprising:
the coated particles defined by claim 1; and
a fluid which disperses the coated particles therein and transfers the coated particles to the fractures.

19. The injection material as claimed in claim 18, wherein the fluid includes at least one of a solvent, a viscosity modifier, a surfactant, a breaker, a viscosity stabilizer, a gelling agent and a stabilizer.

20. The injection material as claimed in claim 18, wherein an amount of the coated particles contained in the injection material is in the range of 1 to 99 wt %.

21. A packing method for packing particles in fractures formed in a subterranean formation by transferring the injection material defined by claim 18 to the fractures through a wellbore penetrating the subterranean formation to inject the injection material into the fractures.
